(19) United States
(12) Patent Application Publication
(10) Pub. No.: US 2002/0023051 A1
(43) Pub. Date: Feb. 21, 2002

(54) System and method for recommending financial products to a customer based on customer needs and preferences

(76) Inventors: Adrian E. Kunzle, Wilmington, DE (US); Michael K. Forbes, Chadds Ford, PA (US); Michael Elliott, Sanger, TX (US)

Correspondence Address: HUNTON AND WILLIAMS, 1900 K STREET N W, WASHINGTON, DC, 20006, US

(21) Appl. No.: 09/540,265

(22) Filed: Mar. 31, 2000

(51) Int. Cl. G06F 17/60

(52) U.S. Cl. 705/38

(57) ABSTRACT

A system and method for enabling a customer to apply for a plurality of financial products (e.g., automobile loan, mortgage, home equity loan, credit card) simultaneously. The system obtains information about the customer at a first point of contact. An application is completed using the information. Based on the information, the system utilizes a profiling method to determine whether one or more financial products are available to the customer. A determination may be based on a single score calculated using the information and information provided in the application which corresponds to one or more underwriting criteria and policy rules. The score and application may be applied to each financial product. The determination may also include approving the application for the one or more financial products. The system may then recommend the one or more financial products to the customer. The customer may accept and close one or more of the financial products recommended.

### FIELD OF THE INVENTION

The invention relates to a system and method for recommending and providing customized terms for one or more financial products to a customer based on customer needs, preferences, credit history, and financial circumstances. More particularly, the invention relates to a system and method that recommends one or more financial products to a customer without requiring the customer to select a particular category of financial product at the outset of the transaction.

### BACKGROUND OF THE INVENTION

Systems that enable customers to apply for a loan or other financial product or service are known. Typically, a customer selects a loan or other financial product for which to apply. The financial product may be a mortgage loan, home equity loan, automobile loan, credit card, etc. The customer then completes an application directed to that particular loan or other financial product. In the case of a loan, the application may request personal information related to the loan product from the customer. The personal information may include customer name, address, social security number, income, debts, assets, collateral, etc. The system may also retrieve information related to the customer (e.g., credit report). Based on the information obtained, the system may provide the customer with a list of available loans within that loan product.

Some systems enable the customer to request approval for a loan application. The customer may select a particular loan from the list of available loans and request approval. Such systems determine whether the loan application meets a minimum criteria (e.g., credit score, debt-to-income ratio, etc.), for that loan. If the minimum criteria is met, the loan application is approved. Otherwise, the loan application may be denied. Some systems calculate separate credit scores for each financial product for which the customer is applying.

As described above, some prior systems require that a customer select a particular loan product before applying for a loan. Thus, the customer is limiting the number of loan products that may be available to him. This is a drawback. Other problems and drawbacks also exist with current systems, such as the need for the consumer to undertake several steps, or wait significant periods of time in which to obtain a decision on his loan application, or to receive a disbursement of funds pursuant to the completion of the financial transaction.

### SUMMARY OF THE INVENTION

An object of the invention is to overcome these and other drawbacks.

Another object of the invention is to provide a system and method for recommending one or more financial products to a customer.

Another object of the invention is to provide a system and method for recommending one or more financial products to a customer, based upon a single set of data obtained from the customer.

Another object of the invention is to provide a system and method for recommending one or more financial products to a customer that does not require a customer to select a category of financial product.

Another object of the invention is to provide a system and method that varies a price of a financial product based on personal and financial information provided by the customer and the purpose of the use of the funds.

Another object of the invention is to provide a system and method for recommending one or more financial products to a customer based upon information obtained from the customer at the first point of contact which is relevant to the one or more financial products.

Another object of the invention is to provide a system and method for recommending one or more financial products to a customer that determines financial products available to the customer based on a single score calculated using information provided by the customer and retrieved from other sources.

Another object of the invention is to provide a system and method for recommending one or more financial products to a customer that approves the customer for the one or more financial products recommended.

Another object of the invention is to provide a system and method for recommending one or more financial products to a customer that enables the customer to select, accept, and close one or more financial products with little or no human intervention.

Another object of the invention is to provide a system and method for recommending one or more financial products to a customer that services a closed financial product.

To achieve these and other objects, and in accordance with the purpose of the invention, as embodied and broadly described, an embodiment of the invention comprises a system and method for recommending one or more financial products to a customer. As used herein, a financial product includes any product offered by a financial institution. Such products may include, but are not limited to, loans (e.g., mortgage, automobile, boat, recreational vehicle, student, home equity), lines of credit, savings accounts, checking accounts, credit cards, debit cards, certificates of deposit, etc. The invention enables a customer to apply for two or more of the financial products simultaneously without requiring the customer to select a particular financial product at the outset of the transaction, or to complete a separate application for each financial product.

According to one embodiment of the invention, a system and method are provided for recommending one or more financial products to a customer based on customer needs, preferences, and financial condition. The system and method obtain information about a customer's needs, preferences, and financial eligibility for a financial product preferably at a first point of contact with the customer. Additional customer information (e.g., credit report) may also be obtained from other sources. An application may be generated comprising the information received from the customer, including personal and financial information. The system may then profile the customer based on the information received. The profile may be used to determine a category of financial product that may satisfy a customer's needs and preferences, and for which the customer is financially eligible. Based upon this determination, the system may recommend one or more financial products to the customer and provide a quotation of the basic features or terms of the financial product, such as an interest rate, fees and loan term. The one or more financial products recommended may also be approved for the customer as part of this same transaction. Approval notifies the customer that one or more particular financial products are available and enables the customer to accept the financial products which fit his/her preferences and requirements. If one or more financial products are not available to the customer, the system may decline the application and generate regulatory documentation notifying the customer of the denial and retrievably archive the regulatory documentation generated.

The system may then enable the customer to select and accept one or more of the financial products recommended. The customer may also select offers or options related to the one or more financial products. The system may enable the customer to modify the financial products, offers, and options selected. If the financial product, offers and options selected and accepted by the customer require the posting of collateral by the customer, the system may then gather and verify any information regarding the collateral identified by the customer. Next, the system may prepare documentation related to the one or more financial products selected (and possibly offers and options), and forward the documentation to the customer. The system then enables customers to complete an application. Upon completion, the system may perfect the application and fulfill any obligations placed on the financial institution according to the terms of the documentation. Depending on the specific embodiment in use, the system may also service a financial product during a term of the financial product, by performing such functions as posting payments to an account and taking action to collect overdue payments.

Additional features and advantages of the invention will be set forth in the description that follows, and in part will be apparent from the description, or may be learned by practice of the invention. The objectives and other advantages of the invention will be realized and attained by the system and methods, particularly pointed out in the written description and claims hereof as well as the appended drawings.

### BRIEF DESCRIPTION OF THE DRAWINGS

FIG. 1 is a block diagram of a method for recommending one or more financial products to a customer in accordance with one embodiment of the invention.

FIG. 2 is a block diagram of a method for determining whether to approve a customer for one or more financial products in accordance with one embodiment of the invention.

FIG. 3 is a block diagram of a method for adjusting financial product offers and options in accordance with one embodiment of the invention.

FIG. 4 is a block diagram of a system for recommending one or more financial products to a customer in accordance with one embodiment of the invention.

### DETAILED DESCRIPTION OF THE INVENTION

As discussed in the Summary of the Invention, the invention is directed to a system and method for recommending one or more financial products to a customer. According to a preferred embodiment, the invention is utilized with a single financial institution and operated using an Internet-based system. For example, a customer may access a web site of a financial institution using a standard web browser such as Netscape Navigator or Microsoft's Internet Explorer, apply for one or more financial products simultaneously, and receive a decision on this application, along with a quotation of several terms of the financial product.

The system recommends one or more financial products to a customer based on customer needs, preferences, and financial condition. The system enables a customer to apply for several financial products simultaneously without requiring the customer to select a particular financial product for which to apply at the outset of the transaction. According to a preferred embodiment of the invention, information is obtained at a first point of contact with a customer. The customer may input various information (e.g., name, address, social security number, loan amount, loan purpose, income, other debts, etc.). The system may obtain additional information (e.g., credit history) from other sources (e.g., a credit bureau database). An application may be generated including the information received from the customer and from the other sources. Based on the information received, the system may determine which product(s) meet the customer's needs and preferences and may be beneficial to the customer. The determination is preferably based at least in part on a credit score calculated using the information received. More preferably, only a single score needs to be calculated and used in determining which, among a plurality of financial products, the customer is eligible for.

For example, a customer may desire a loan for making improvements to a home. The customer may desire a $20,000 loan, but prefer that the loan be repaid in a relatively short time. The customer indicates that he/she is willing to pay a higher monthly payment for a shorter loan term. Based on the information received, the system may determine that a home equity loan may enable the customer to repay the loan in ten (10) years with a higher payment, than with a second mortgage loan having a lower payment for fifteen (15) years. Therefore, the system may recommend a home equity loan to the customer as a first choice, and a second mortgage loan as a second choice.

Alternatively, the customer may indicate that he/she prefers a low monthly payment. The system may then determine that, based on the information received, the customer may obtain a credit card with a credit limit of at least $20,000 and be able to have a low payment by paying a minimum payment charge each month. The system may then recommend the credit card to the customer as a first choice. The system may also approve a customer for a recommended financial product. Such an approval may also include a quotation of such terms of the transaction as an interest rate, the duration of the loan term (e.g. 10 years or 30 years, etc.), and any fees or other charges associated with the financial product. Preferably, these terms are set based upon the creditworthiness or financial condition of the customer.

The system also enables customers to select and accept one or more other financial products from the one or more financial products recommended (or other financial product offered by the financial institution but not recommended). Financial products selected by the customer may also provide other related offers and options. For example, if a checking account is selected, the customer may be offered overdraft protection, if a credit card is selected, the customer may be offered a direct payment option, etc. Credit insurance or title insurance for a home may also be offered as options. The system may enable the customer to accept one or more financial products and related offers and options.

If a financial product (and possibly other offers and options) is accepted, the system determines whether collateral is required to be provided by the customer, and may verify any collateral identified by the customer. In addition, the system may prepare documentation relating to the financial product offers and options. The documentation may be forwarded to the customer and the system may enable the customer to complete the application. Completion of the application may be performed, for example, electronically or manually. If electronic completion is chosen, the documentation may be forwarded to the customer electronically (e.g., via electronic mail or by downloading a file from an Internet site). The customer may then complete the application using an electronic signature (e.g., digital signature) and return the documentation electronically. Alternatively, the documentation may be forwarded via regular mail and the customer may sign and return the documentation to the financial institution using known methods.

The system may also provide additional functions, for example, perfecting, fulfilling, and servicing. Perfecting may be used to determine whether an application is in compliance with application procedures (e.g., all required fields contain a valid entry, any liens or security interests in collateral have been recorded). The fulfilling function of the system may be used to perform any actions required of the financial institution (e.g., dispersing funds, creating accounts). Servicing may be used to perform a variety of actions required during the term of a financial product (e.g., book payments and withdrawals, create statements, generate reports and accounting entries). According to a preferred embodiment of the invention, the system operates in a closed-loop fashion (i.e., without human intervention).

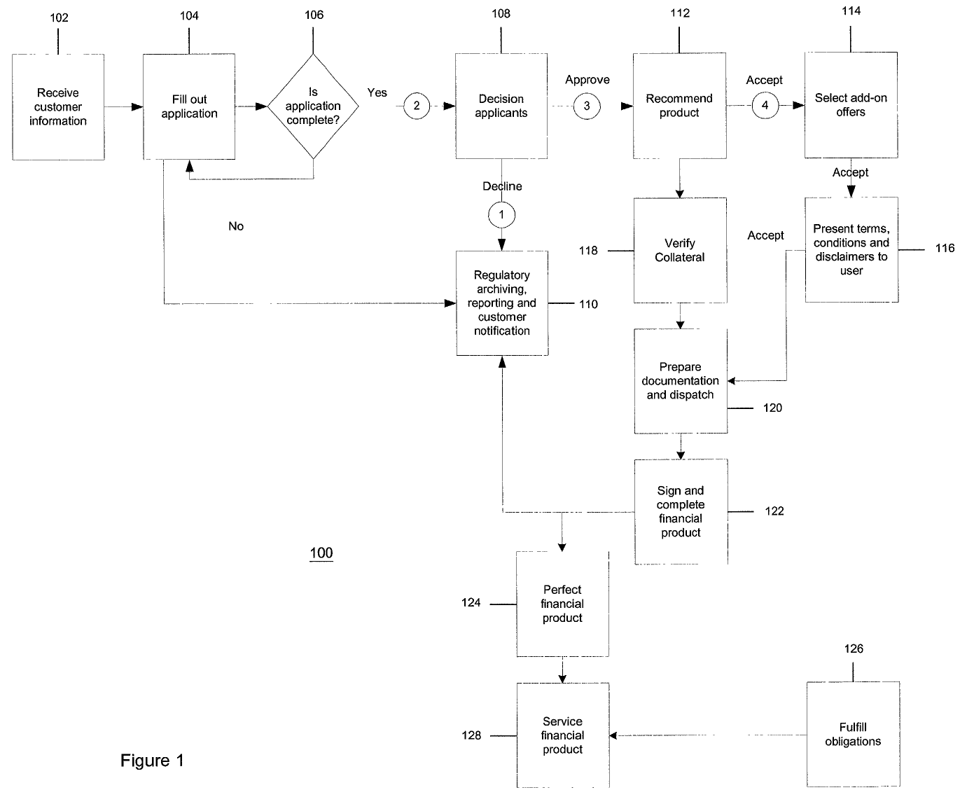

FIG. 1 illustrates a method 100 for recommending one or more financial products to a customer according to one embodiment of the invention. Method 100 may be performed using a closed-loop system (i.e., without human intervention), or a telemarketing system which requires one or more human operators. Method 100 is described first in terms of a closed-loop system utilizing conventional computer equipment accessible over the internet by a plurality of customers simultaneously. As stated above, as used herein, the term financial products is intended to include any financial product offered by a financial institution. Financial products include, but are not limited to, loans (e.g., mortgage, home equity, automobile, boat, recreational vehicle, student), lines of credit, checking accounts, savings accounts, credit cards, debit cards, etc. Method 100 comprises step 102. Step 102 equity may be used to request and receive customer information. The request may be displayed on a conventional computer monitor, personal digital assistant, mobile phone, television, or any known display device. The customer information preferably comprises information corresponding to the predetermined underwriting criteria or policy rules established by the financial institution for the financial products that it offers. This may include identifying information, customer needs and preferences, and the customer's financial situation. Such customer information may include, for example, name, address, social security number, loan amount, as well as whether a low interest rate, low monthly payment, or a particular loan term is preferred. Other customer information such as the purpose of the loan, the amount of the customer's other debt, whether the customer owns a home, and whether the customer believes interest rates are going to increase or decrease, etc., may also be collected. The customer information may be input using known methods (e.g., conventional computer keyboard or voice recognition software). Step 102 may also enable a customer to anonymously browse and view available financial products, rates, and terms. Step 102 may also enable a customer to incrementally input collateral and personal financial information to refine financial product offerings, rates, and terms.

Method 100 may utilize the customer information to generate an application using step 104 in a format which corresponds to the underwriting criteria or policy rules for the financial products offered by the financial institution. The application may be financial product specific or financial product independent. Additionally, step 104 may retrieve information known about a customer and insert that information into the application without requesting input from the customer regarding that information. For example, known information gained from prior marketing solicitations or customer contacts may be pre-filled into the application, or not presented to nor requested from the customer.

Pre-filling of information may be performed by requesting a solicitation number from the customer. If the customer was provided a solicitation number during a previous communication with the financial institution, method 100 may receive the solicitation number input by the customer. Method 100 may then retrieve any information previously supplied by the customer and pre-fill that information into the application. Alternatively, method 100 may utilize a combination of customer input information (e.g., name and address, social security number and phone number) to retrieve information previously supplied by the customer (e.g., income, employer). Method 100 may request that the customer confirm whether the information retrieved is accurate. Pre-filling information has various advantages. For example, pre-filling reduces the amount of time a customer expends while filling-in an application and simplifies an application process.

The application may be used to enable the customer to apply for a plurality of financial products simultaneously without necessarily requiring the customer to select the type of product at the outset of the transaction. To accomplish this, the customer may be requested to provide personal and financial information which corresponds to the underwriting criteria and policy rules for the financial products offered by the financial institution. For example, the same application may be used to enable the customer to apply for a home equity loan, personal loan, automobile loan credit card, etc. The step of applying for a plurality of financial products may be transparent (e.g., unknown) to the customer, or the customer may be notified that the application may be used to apply for a plurality of financial products. If the customer is notified that the application may be used to apply for a plurality of financial products, the customer may be provided an option to select, that limits the financial products for which to apply.

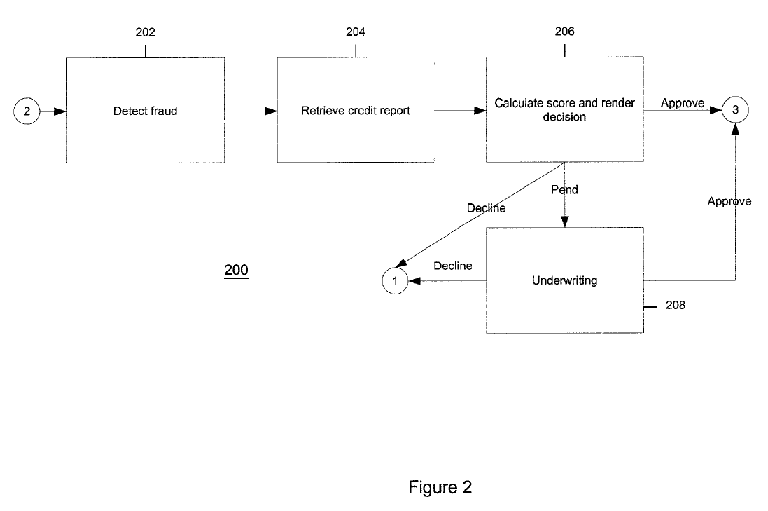

Step 106 may be used to determine whether the application is complete. If the application is not complete, method 100 may return to step 104 and prompt the customer for additional or corrected information. If, however, the application is complete, method 100 may determine whether one or more financial products are available to the customer using step 108. Step 108 may comprise a plurality of steps as shown in FIG. 2.

FIG. 2 illustrates a method for determining whether one or more financial products are available to a customer in accordance with one embodiment of the invention. Step 108 may comprise fraud detecting step 202, credit report retrieving step 204, score calculating and decision rendering step 206, and underwriting step 208. Fraud detecting step 202 may be used to detect obvious or other types of fraud input by a customer. For example, fraud detecting step 202 may be used to detect invalid input (e.g., entering a name of a cartoon character, a birth date indicating that the customer may be below eighteen (18) years of age, a non-existent city, state, zip code or social security number). If no indications of fraud are detected, method 100 may continue with step 204. Step 204 may be used to retrieve the customer'credit report utilizing the customer information provided. This may be performed using known methods of credit report retrieval systems, such as the Magnum software engine. For example, the system may access a database of a credit bureau and retrieve a credit report for that customer.

Method 100 may then calculate a credit score and render a decision regarding the application using step 206. According to a preferred embodiment of the invention, step 206 calculates a single credit score utilizing a single scorecard that may be applied to a plurality of financial products. Alternatively, multiple scorecards may be used for various financial products. Scorecards from multiple financial products may then be used to generate a single scorecard to be applied to a plurality of financial products. The single scorecard calculated in this manner may be combined with a plurality of entries of information personal to the customer which are entered on the customer's application which correspond to the underwriting criteria and policy rules for the one or more financial products offered by the financial institution. These underwriting criteria and policy rules may include a minimum credit score, a maximum credit score, debt to income ratio, whether the customer owns a home, the value of the collateral relative to the loan amount, or the number of historical past due payments, which may indicate or predict an unwillingness or inability to fulfill the terms of a particular financial product. The use of a single credit score calculated from a single scorecard and a single application reduces a need to create separate scorecards, calculate multiple credit scores, and complete separate applications for separate financial products.

In step 206, the credit score and the intermediate scores and values for the underwriting criteria or policy rules presented on the application are then compared to underwriting criteria and policy rules for each of the one or more financial products residing in the system. The underwriting criteria may require the policy rules for a particular financial product. Such policy rules may be the requirements for approval of an application for a financial product and the requirements for a particular level of pricing for such financial product to the customer. If, for example, a customer is applying for a home equity loan, policy rules may require that the customer own a home for a predetermined number of years and have a loan-to-equity ratio (based on the collateral) below a predetermined threshold in order to be approved that financial product at a particular price level.

Preferably, a decision regarding the application is based at least in part on the credit score and the entries placed on the customer's application. If the overall credit score or an intermediate value stated for a factor on the application is below a predetermined threshold for each of the financial products recommended, the application may be declined and the customer notified accordingly. Alternatively, if the credit score or an entry in the application document is below a predetermined value set by the underwriting criteria or policy rules, the financial product may be offered to the customer at a higher interest rate or with higher associated fees, etc. If the credit score or an entry in the application document is within a certain range of the predetermined threshold, method 100 may go to step 208. Step 208 may perform known underwriting methods to determine whether the application should be approved. Such known underwriting methods may be undertaken without human intervention in a closed-loop system, otherwise a human underwriter may employ conventional methods of financial analysis to determine whether to accept or decline the application as part of step 208. If step 208 determines that the application should be declined, the customer may be notified to such effect, otherwise, the application may be approved. If step 206 determines that the credit score or intermediate values for relevant factors stated on the scorecard are above a predetermined threshold for one or more financial products, the customer may be approved for that financial product.

In an alternative embodiment, the personal and financial information retrieved from the customer as part of step 102 is input directly into decisioning step 206 without the requirement that a formal application first be completed by the customer. In this way, the customer may provide a level of personal and financial information sufficient to meet the underwriting criteria and policy rules for each financial product recommended.

Returning to FIG. 1, if either step 206 or step 208 determine that an application should be declined, method 100 may generate, forward to the customer, and retrievably archive regulatory documentation using step 110. Regulatory documentation may be used to notify the customer that an application has been declined and advise the customer regarding any rights the customer may have related to the denial.

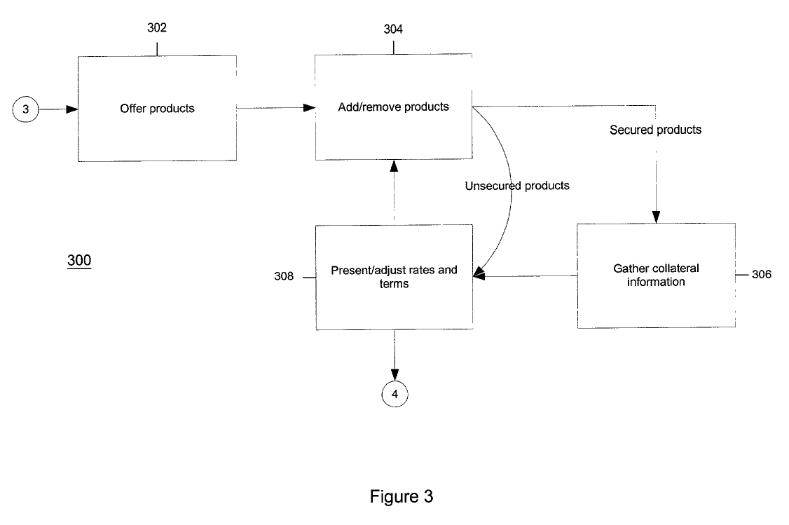

If either of steps 206 or 208 approve the application, method 100 may recommend the approved (or other) financial products to the customer using step 112. Step 112 may comprise a plurality of steps as illustrated in FIG. 3.

FIG. 3 illustrates a method of offering financial products to a customer in accordance with one embodiment of the invention. Step 112 may comprise offer products step 302, add/remove products step 304, gather collateral information step 306, and present/adjust rates and terms step 308. Step 302 may be used to offer a list of one or more approved (or other) financial products to the customer. Other financial products offered to the customer may be financial products specifically requested by the customer. Step 304 may be used to enable the customer to input information specific to a particular financial product and add or remove one or more financial products from the list.

If the customer selects a secured financial product, method 100 may gather information regarding the collateral presented by the customer using step 306. Collateral information may be gathered by requesting information from other sources (e.g., databases and on-line public record search engines) storing such information. If the customer selects an unsecured product, a combination of secured and unsecured products, or a secured product whose collateral information has been gathered using step 306, method 100 may adjust financial product rates and terms and present the rates and terms to the customer using step 308. Step 112 may, for example, provide an iterative process wherein the customer may select and deselect numerous financial products in step 304 and alter modifiable terms as designated by a financial institution in step 308 until he reaches a desired selection of financial products and terms. Preferably, if a change is made to the list of financial products presented, or to the terms for a particular financial product or set of products, step 308 presents the customer with updated information reflecting the change. Step 112 may also modify the list of recommended products and recalculate terms based on a customer selection. For example, if the customer selects an option that is not available with one or more recommended financial products, then step 112 may remove those financial products from the list. Additionally, if the customer selects an option for a lower down payment on a mortgage loan, then step 112 may recalculate the rate for that mortgage loan.

Returning to FIG. 1, according to one embodiment, after the customer accepts one or more financial products, method 100 may proceed to step 114. Step 114 may be used to enable the customer to select one or more options related to the financial products. For example, if the customer selects a checking account, step 114 may offer the customer an option of selecting overdraft protection for the checking account. Similarly, if the customer selects a mortgage loan, the customer may select an automated payment plan wherein each monthly payment is automatically withdrawn from a pre-selected account. Other options such as credit insurance or title insurance for a home may also be presented to the customer, depending upon the type of financial product selected. If the customer selects one or more (or none) of the options, method 100 may present terms, disclaimers, and conditions relating to the financial products and options selected using step 116.

According to another embodiment, method 100 may proceed from step 308 to step 118 for products that the customer has selected that require collateral or verification of other conditions, such as income. Step 118 may be used to verify collateral information or information relating to the conditions gathered in step 306. If the collateral information is verified, method 100 may proceed to step 120. Similarly, if the customer accepts the terms, disclaimers, and conditions presented in step 116, method 100 may proceed to step 120. Step 120 may be used to prepare and forward to the customer application documentation relating to the financial products and offers selected. If step 118 was executed, step 120 may not commence until steps 1 16 and 118 are completed. At this point, the application may be unconditionally approved for the one or more financial products.

Step 120 preferably prepares application documentation reflecting legal obligations of the customer and financial institution and requiring a customer signature. Step 120 may forward the application documentation to the customer electronically (e.g., via electronic mail or by downloading a file from an Internet site). After receiving the application documentation, the customer may, using step 122, complete the application by inserting, for example, a facsimile or digital signature (or other method approved by law), thus completing the application. The application documentation may then be retrievably archived, and regulatory documentation prepared, using step 110.

After an application is completed, method 100 may perfect the application using step 124 and fulfill obligations using step 126. Step 124 may be used to determine whether an application complies with predetermined requirements established by a financial institution accepting the application (e.g., verify employment). Step 124 may also be used to verify whether security interests held by the financial institution in any collateral posted by the customer have been perfected, such as by recording a mortgage, deed of trust or other lien. Step 126 may be used to fulfill obligations of the financial institution related to the financial products. For example, step 126 may be used to disperse funds to the customer and/or business partners of a financial institution (through a commission structure or similar arrangement), as well as create accounts to receive deposit of such funds for the customer and for receiving payments from the customer.

Method 100 may also include a financial product servicing step 128. The financial product servicing step may be used to perform functions related to the financial product during a term of the financial product. For example, step 128 may include monitoring financial transactions, posting payments and disbursements of funds, creating statements, generating reports and accounting entries, terminating the servicing upon fulfillment of the conditions set forth in the documentation, etc.

According to another embodiment, the invention may be used in conjunction with telemarketing. That is, instead of having a customer input information directly into the system via such vehicles and an Internet-based user interface, the customer may provide the information to a representative of a financial institution, such as a telemarketer.

The method utilized may be the same as described above, however, the customer may contact the financial institution's telemarketing operation directly or he may have been contacted by a telemarketer pursuant to the financial institution's marketing program. According to this embodiment of the invention, the customer provides the telemarketer with requested information similar to that which is obtained from the customer through the Internet-based embodiment described above. The telemarketer inputs the information received from the customer (and possibly other sources such as a credit bureau) into a system for recommending one or more financial products in order to create an application therefore. The telemarketer then notifies the customer of decisions made by the system to accept or decline his application based on the application and the credit score calculated using the method described above, and requests any additional information from the customer needed by the system to make such a decision.

One distinction, however, may be that if the customer accepts a financial product, any documentation prepared may be forwarded to the customer via regular mail (or other carrier) for a personal signature. The customer may then return the documentation to the financial institution in a similar manner. It should be noted, however, that according to the telemarketing embodiment, it is also contemplated that the customer may receive the documentation electronically (e.g., via electronic mail) and complete the application in the manner described above (i.e., by inserting a digital signature and returning the documentation via electronic mail).

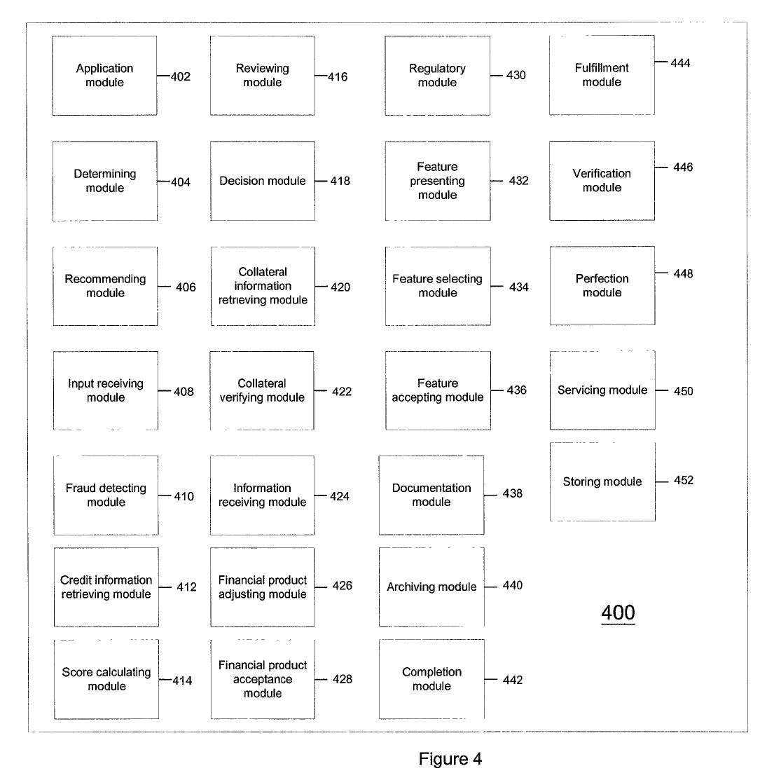

FIG. 4 illustrates a system 400 for recommending one or more financial products to a customer in accordance with one embodiment of the invention. System 400 preferably is a closed-loop system (i.e., requires no human intervention other than with a customer) and operates on a client-server architecture, although the invention is not limited to such an architecture. System 400 preferably operates in cooperation with the a web server of a financial institution. The server is preferably accessible by a plurality users of the Internet and World Wide Web. The system should allow for a plurality of users to access the system simultaneously. According to a preferred embodiment of the invention, a customer accesses a web site of a financial institution (e.g., using a conventional web browser such as Netscape or Microsoft's Internet Explorer) and is presented with a graphic user interface or views' enabling the customer to apply for one or more financial products simultaneously. The customer may be presented with a single or series of views enabling the customer to input information regarding one or more financial products. The information which the customer may be prompted to input should correspond to one or more predetermined underwriting criteria or policy rules for the one or more financial products offered by the financial institution. System 400 enables the customer to select, modify, accept, and complete an application for a plurality of financial products simultaneously. One or more modules (described in further detail below) may be used to implement system 400. Although system 400 is described in terms of a plurality of modules, it is to be understood that all modules may be incorporated into a single module or two or more modules may be combined into a single module.

System 400 may comprise a plurality of modules as shown in FIG. 4. System 400 may comprise an application module 402. Application module 402 may be used to enable a customer to submit an application for a plurality of financial products simultaneously with or without specifying a particular type of financial product at the outset of the transaction. Application module 402 reduces the need to have a customer submit a separate application for each financial product that he may be interested in or eligible for. This is so, because in the preferred embodiment, the application prompts the customer to input personal and financial information which corresponds to the underwriting criteria and policy rules for the one or more financial products offered by the financial institution.

System 400 may also include a determining module 404. Determining module 404 may be used to determine the financial products available to the customer based on the application. If determining module 404 determines that one or more financial products are available to the customer, recommending module 406 may be used to recommend those financial products to the customer.

System 400 may also include an input receiving module 408 that may be used to receive input from the customer. Input receiving module 408 may receive input via a conventional computer keyboard, voice recognition software, personal digital assistant, telephone keypad, or other input device. Input may be personal or financial information about the customer, the customer's needs or preferences, etc. A fraud detecting module 410 may be used to detect whether information input by a customer is potentially fraudulent. For example, fraud detecting module 410 may be used to verify a name, address, or social security number.

System 400 may also comprise a credit information retrieving module 412 that may be used to obtain additional credit information about a customer from other sources. For example, credit information retrieving module 412 may access a database of an authorized credit bureau (e.g., EQUIFAX™). Credit information retrieving module 412 may retrieve credit information (e.g., a credit report) about the customer and enable system 400 to utilize the credit information in determining which financial products to recommend.

A score calculating module 414 may utilize the information received by input receiving module 408 and credit information retrieving module 412 to calculate a single credit score for the customer based upon a plurality of factors set forth on a single scorecard. The factors set forth in the scorecard, such as the amount of the consumer's debts, the number of historical past due payments, any incidents of bankruptcy, etc. are selected to correspond to a set of underwriting criteria and policy rules stored in the system for each and every financial product offered by the financial institution, so that only one scorecard is required to be generated for each customer.

The credit score may be used as a threshold in determining whether any financial products are available to the customer. That is, each financial product offered by a financial institution may have a predetermined threshold credit score that a customer must meet for that financial product to be available to the customer. For example, a mortgage loan may have a threshold credit score of 600. If a customer credit score is below 600, that mortgage loan may not be available to the customer. If the customer credit score is above 600, then the mortgage loan may be available to the customer. This determination may be made by decision module 418, as described below. It should be noted, however, that some financial products (e.g., a savings account) may have a threshold credit score of zero (0).

System 400 may also comprise a reviewing module 416 that reviews an application to determine whether the application is in compliance with guidelines or rules set by the financial institution a particular product. If reviewing module 416 determines that the application complies with financial institution requirements, a decision module 418 may be used to render a decision regarding whether to approve or decline the application (or submit the application to underwriting for further financial analysis).

The decision module 418 compares the credit score for the customer and each relevant intermediate value or entry found on the customer's application with a set of pre-determined underwriting criteria and policy rules for each of the one or more financial products for which the customer is found eligible based on his credit score. Although the consumer's credit score may be above the minimum threshold set by the underwriting criteria set for a particular loan product, the decision module 418 will nonetheless compare each intermediate value or entry found on the application for the customer with the underwriting criteria for each potentially available financial product to determine whether any such intermediate application value or entry would render the consumer ineligible for that particular financial product or for a particular product pricing level. For example, if the customer's raw credit score is 600 and above the minimum required score, but his application indicates that he does not own a home which he can offer as collateral, the decision module 418 may determine that the customer is not eligible for a home equity loan or line of credit whose underwriting criteria requires that the customer own a home. Alternatively, if the customer owns a home, but other values or entries on the customer's application fall below one or more of the requirements of the underwriting criteria and the policy rules, then decision module 418 may call for the financial product adjusting module 426 to adjust the pricing (e.g. interest rate and fees) and other terms of the financial products, such as the duration of the loan term, in order to reflect an increase in the risk associated with the transaction.

In an alternative embodiment, a subset of the personal and financial information that may be required from the customer to be approved for a loan by the preferred embodiment of system 400 may be input directly into decision module 418. Decision module 418 may provide one or more recommendations of financial products to the customer based on this subset of information despite the customer not having provided an amount or level of personal and financial information sufficient to meet the all of the underwriting criteria and policy rules required for approval of the one or more financial products recommended. Decision module 418 may also provide input receiving module 408 with details of the additional information required from the customer in order for decision module 418 to reconsider the currently recommended products with the objective of refining the list of recommended products to be products where the customer has provided a level of personal and financial information sufficient to meet all of the underwriting criteria and policy rules for the one or more financial products recommended. This process of reevaluating the list of recommended financial products may be iterative, driven by the customer, and repeated multiple times as the customer provides progressively more detailed personal and financial information.

If an application for a secured financial product, such as a mortgage, home equity loan, automobile or boat loan is approved, a collateral information retrieving module 420 may be used to obtain information regarding collateral identified by a customer to secure the financial product. A collateral verifying module 422 may then be used to verify the information concerning collateral identified by the customer.

If a customer selects a recommended (or other) financial product, an information receiving module 424 may be used to obtain information specific to that financial product from the customer. For example, the customer may be offered specific rates and terms to select. The customer may also be asked to select from secured and unsecured products. Information receiving module 424 may be used to receive selections input by the customer. If information receiving module 424 receives input from the customer, a financial product adjusting module 426 may be used to adjust the financial product and its terms according to the types of financial products selected (i.e., secured or unsecured) input rates, term, or other information.

System 400 may perform risk-based pricing. For example, if a customer selects one secured and one unsecured financial product (as opposed to two unsecured products), the interest rate may be adjusted downward to reflect the lower risk. The financial product adjusting module 426 may also be used by the decision module 418 to adjust the pricing (e.g. interest rate and fees) and other terms (such as the time duration) of the one or more financial products recommended in order to reflect the increased risk of the transaction determined by the decisioning module 418. A financial product acceptance module 428 may be used to enable the customer to accept one or more of the recommended financial products (whether the financial product was adjusted).

A regulatory module 430 may be used to generate and retrievably archive regulatory documentation. The regulatory documentation may be generated whether an application is approved or declined for one or more financial products. If an application is declined, regulatory module 430 may generate regulatory documentation notifying and advising the customer of the decline and of any rights the customer may have. If, however, an application is approved, regulatory module 430 may generate regulatory documentation identifying terms, conditions, and disclaimers related to the financial product. Regulatory module 430 may also be used to store and retrievably archive the customer's application itself.

System 400 may also comprise a feature presenting module 432 that may be used to present a customer with one or more optional features available for the financial products. For example, feature presenting module 432 may present the customer with an overdraft feature for a checking account, automatic payment for a mortgage loan, credit card, etc. Other features or options may include credit insurance or title insurance for mortgage loans. Feature presenting module 432 may also present the customer with terms, conditions, and disclaimers related to the one or more features. A feature selecting module 434 may be used to enable the customer to select one or more of the features offered by the feature presenting module 432 for a financial product. If a customer selects one or more features, a feature accepting module 436 may be used to accept the one or more features selected.

If a customer accepts one or more financial products (and possibly one or more features), a documentation module 438 may be used to prepare documentation relating to the financial products and features. For example, documentation module 438 may prepare legal documentation requiring customer signature to enable the customer to complete the application. Documentation module 438 may also forward the documentation to the customer. Documentation may be forwarded personally (such as at a branch of the financial institution), via regular mail or other carrier, facsimile, electronically (e.g., via electronic mail), or other method. An archiving module 440 may be used to retrievably archive documentation relating to the financial products and features. Archiving may be performed before, during, or after (or any combination thereof) the documentation is forwarded to the customer. A financial product completion module 442 may be used to enable the customer to complete the application for one or more financial products. This may be performed, for example, by enabling the customer to sign the documentation. The customer may sign the documentation manually and return the documentation to the financial institution using any known carrier, or electronically. If a customer signs the documentation electronically, this may be performed using a facsimile or digital signature (or other method approved by law). The customer may then return the documentation electronically or using other known methods (e.g., regular mail, overnight carrier).

After an application is complete, a financial product fulfillment module 444 may be used to fulfill any financial institution obligations. For example, a financial product may require that one or more accounts be created or funds be dispersed to the customer.

System 400 may also include a financial product verification module 446 that verifies all information provided in the documentation. A financial product perfection module 448 may also be used to determine whether the application is in compliance with the documentation. For example, financial product perfection module 448 may be used to determine whether all required application fields contain a valid entry. Product perfection module 448 may also verify whether the financial institution's security interest in collateral provided by the customer has been perfected, such as by the recordation of a mortgage, deed of trust or other lien.

If the application and documentation are determined to be in compliance with financial institution requirements, a financial product servicing module 450 may be used to service the financial product. Servicing may include monitoring financial transactions, posting payments or disbursements of funds (such as through a line of credit), generating statements and accounting entries, and terminating the servicing upon fulfillment of the terms set forth in the documentation. A storing module 452 may be used to store documentation relating to the underwriting criteria and policy rules for the one or more financial products offered.

Other embodiments and uses of this invention will be apparent to those having ordinary skill in the art upon consideration of the specification and practice of the invention disclosed herein. The specification and examples given should be considered exemplary only, and it is contemplated that the appended claims will cover any other such embodiments or modifications as fall within the scope of the invention. For example, for clarity, the invention is described in terms of one financial institution. It is to be understood, however, that the invention may also be utilized with a plurality of financial institutions who each offer a plurality of financial products to customers through the system and method of the invention.

What is claimed is:

1. A system for recommending one or more financial products to a customer, wherein the customer applies for a plurality of financial products simultaneously and said financial products comprise one or more types of financing, the system comprising:
an application module that enables a customer to submit an application for a plurality of financial products;
a determining module that determines said financial products available to said customer; and
a recommending module that recommends said financial products available to said customer.

2. The system of claim 1, further comprising an input receiving module that receives input from said customer.

3. The system of claim 2, wherein said input received at said input receiving module comprises personal information of said customer.

4. The system of claim 2, further comprising a fraud detecting module that detects fraudulent input from said customer.

5. The system of claim 2, further comprising a credit information retrieving module that retrieves credit information pertaining to said customer.

6. The system of claim 5, further comprising a score calculating module that calculates a score for said customer based on said input from said customer and said credit information.

7. The system of claim 1, further comprising a reviewing module that reviews an application for said financial products.

8. The system of claim 1, further comprising a decision module that renders a decision regarding said application for said financial products.

9. The system of claim 1, further comprising a collateral information retrieving module that retrieves information regarding collateral available to said customer.

10. The system of claim 9, further comprising a collateral verifying module that verifies information about said collateral obtained from said collateral information retrieving module and said customer.

11. The system of claim 1, further comprising an information receiving module that receives information specific to said one or more financial products from said customer.

12. The system of claim 11, further comprising a financial product adjusting module that adjusts said financial products recommended based on said information specific to said financial products.

13. The system of claim 1, comprising a financial product acceptance module that allows said customer to accept or decline said financial products recommended by said recommending module.

14. The system of claim 1, comprising a regulatory module that generates and retrievably archives regulatory documentation for said application for said financial products that is declined by said financial product acceptance module.

15. The system of claim 1, further comprising a feature presenting module that presents one or more optional features available for said financial products applied for by said customer.

16. The system of claim 15, further comprising a feature selecting module that enables said customer to select among said one or more optional features.

17. The system of claim 16, further comprising a feature accepting module that enables said customer to accept said one or more optional features selected.

18. The system of claim 1, further comprising a documentation module that prepares documentation relating to said financial products.

19. The system of claim 18, further comprising an archiving module that retrievably archives said documentation.

20. The system of claim 1, further comprising a financial product completion module that enables said customer to complete said financial products.

21. The system of claim 1, further comprising a financial product fulfillment module that fulfills obligations of a financial service provider under said documentation for said financial products completed by said customer.

22. The system of claim 1, further comprising a financial product verification module that verifies information provided in said application for said financial products.

23. The system of claim 1, further comprising a financial product perfection module that detects compliance or noncompliance with said documentation.

24. The system of claim 1, further comprising a financial product servicing module that services said financial products completed by said customer.

25. The system of claim 24, wherein said financial product servicing module monitors financial transactions regarding said financial products completed by said customer.

26. The system of claim 24, wherein said financial product servicing module generates statements regarding said financial products completed by said customer.

27. The system of claim 24, wherein said financial product servicing module generates accounting entries for said financial products completed by said customer.

28. The system of claim 24, wherein said financial product servicing module terminates said servicing of said financial products completed by said customer.

29. The system of claim 1, wherein said system for recommending recommends said financial products without human intervention.

30. The system of claim 1, wherein said system for recommending varies a price of a financial product based on customer information and purpose of use of funds.

31. A system for recommending one or more financial products to a customer, wherein the customer applies for a plurality of financial products simultaneously, the system comprising:
applying means for enabling a customer to submit an application for financial products simultaneously;
determining means for determining said financial products available to said customer; and
recommending means for recommending said financial products available to said customer.

32. The system of claim 31, further comprising an input receiving means for receiving input from said customer.

33. The system of claim 32, wherein said input comprises personal and financial information of said customer.

34. The system of claim 32, further comprising fraud detecting means for detecting fraudulent input from said customer.

35. The system of claim 31, further comprising credit information retrieving means for retrieving credit information pertaining to said customer.

36. The system of claim 35, further comprising score calculating means for calculating a score for said customer based on said customer input and said credit information.

37. The system of claim 31, further comprising reviewing means for reviewing said application for said financial products.

38. The system of claim 31, further comprising adjusting means for adjusting said financial products recommended based on said information specific to said financial products.

39. The system of claim 31, further comprising acceptance means for enabling said customer to accept or decline said financial products recommended by said recommending module.

40. The system of claim 31, further comprising regulatory means for generating and retrievably archiving regulatory documentation for said application for said financial products that is declined by said acceptance means.

41. The system of claim 31, further comprising decision means for rendering a decision regarding said application for said financial products to said customer.

42. The system of claim 31, further comprising collateral information retrieving means for retrieving information regarding collateral available to said customer.

43. The system of claim 42, further comprising collateral verifying means for verifying said collateral available to said customer.

44. The system of claim 31, further comprising information receiving means for receiving information specific to said financial products from said customer.

45. The system of claim 44, further comprising financial product adjusting means for adjusting said financial products recommended based on said information specific to said financial products.

46. The system of claim 31, further comprising feature presenting means for presenting one or more optional features available for said one or more loan products to said customer.

47. The system of claim 46, further comprising feature selecting means for enabling said customer to select from among said one or more optional features.

48. The system of claim 47, further comprising feature accepting means for enabling said customer to accept or decline said one or more optional features selected by said selecting means.

49. The system of claim 31, further comprising documentation means for preparing documentation relating to financial products approved for said customer.

50. The system of claim 49, further comprising archiving means for retrievably archiving said documentation.

51. The system of claim 31, further comprising financial product completing means for enabling said customer to complete said financial products.

52. The system of claim 31, further comprising financial product fulfilling means for enabling a financial service provider of said financial products to fulfill obligations according to said documentation.

53. The system of claim 31, further comprising financial product verifying means for verifying that information provided in said application is complete.

54. The system of claim 31, further comprising application perfecting means for detecting compliance or noncompliance with said documentation.

55. The system of claim 31, further comprising financial product servicing means for servicing said financial products completed by said customer.

56. The system of claim 55, wherein said financial product servicing means monitors financial transactions regarding said financial products completed by said customer.

57. The system of claim 55, wherein said financial product servicing means generates statements regarding said financial products completed by said customer.

58. The system of claim 55, wherein said financial product servicing means generates accounting entries for said financial products completed by said customer.

59. The system of claim 55, wherein said financial product servicing means terminates said financial products according to said documentation.

60. The system of claim 31, wherein said system for recommending recommends said financial products without human intervention.

61. The system of claim 31, wherein said system for recommending varies a price of a financial product based on customer information and purpose of use of funds.

62. A method for recommending one or more financial products to a customer, wherein the customer applies for a plurality of financial products simultaneously, said the method comprising the steps of:
enabling a customer to submit an application for one or more financial products simultaneously;
determining said financial products available to said customer; and
recommending said financial products available to said customer.

63. The method of claim 62, further comprising the step of receiving input from said customer.

64. The method of claim 63, wherein said input comprises personal information of said customer.

65. The method of claim 63, further comprising the step of detecting fraudulent input from said customer.

66. The method of claim 62, further comprising the step of retrieving credit information pertaining to said customer.

67. The method of claim 66, further comprising the step of calculating a score for said customer based on said customer input and said credit information.

68. The method of claim 62, further comprising the step of reviewing said application for said financial products.

69. The method of claim 62, further comprising the step of enabling said customer to accept or decline said financial products recommended.

70. The method of claim 62, comprising the step of generating and retrievably archiving regulatory documentation for said applications for said financial products that are declined.

71. The method of claim 62, further comprising the step of rendering a decision regarding said application for said financial products made by said customer.

72. The method of claim 62, further comprising the step of retrieving information regarding collateral available to said customer.

73. The method of claim 72, further comprising the step of verifying said collateral available to said customer.

74. The method of claim 62, further comprising the step of receiving information specific to said financial products from said customer.

75. The method of claim 74, further comprising the step of adjusting said financial products recommended based on said information specific to said financial products.

76. The method of claim 62, further comprising the step of presenting one or more optional features available for said financial products to said customer.

77. The method of claim 76, further comprising the step of enabling said customer to select from among said one or more optional features.

78. The method of claim 77, further comprising the step of enabling said customer to accept said one or more optional features.

79. The method of claim 62, further comprising the step of preparing documentation relating to said financial products.

80. The method of claim 79, further comprising the step of retrievably archiving said documentation.

81. The method of claim 62, further comprising the step of enabling said customer to complete said financial products.

82. The method of claim 62, further comprising the step of fulfilling obligations of a financial services provider set forth in said documentation.

83. The method of claim 62, further comprising the step of verifying that information provided in said application for said financial products is complete.

84. The method of claim 62, further comprising the step of servicing said financial products completed by said customer.

85. The method of claim 84, further comprising the step of monitoring financial transactions regarding said financial products completed by said customer.

86. The method of claim 84, further comprising the step of generating statements regarding said financial products completed by said customer.

87. The method of claim 84, further comprising the step of generating accounting entries for said financial products completed by said customer.

88. The method of claim 84, further comprising the step of terminating said servicing of said financial products.

89. The method of claim 62, wherein said method of recommending requires no human intervention.

90. The system of claim 62, wherein said system for recommending varies a price of a financial product based on customer information and purpose of use of funds.

91. A method of application decisioning and pricing for one or more financial products comprising the steps of:
establishing underwriting criteria and policy rules for said one or more financial products;
creating an electronic application for said one or more financial products which corresponds to said underwriting criteria and said policy rules for said one or more financial products;
enabling a customer to submit information for said electronic application which corresponds to said underwriting criteria and said policy rules for said one or more financial products;
using said information from said electronic application submitted by said customer to obtain credit history information for said customer;
calculating a credit score for said customer from said credit history information;
comparing said information from said electronic application and said credit history information for said customer with said underwriting criteria and said policy rules for said one or more financial products;
deciding to accept or reject said electronic application for said one or more financial products.

92. The method of claim 91, wherein the information submitted by said customer for said electronic application comprises a subset of the underwriting criteria and policy rules for said one or more financial products.

93. The method of claim 91, comprising the additional steps of selecting an interest rate to be offered to said customer for said one or more financial products to vary according to said information from said electronic application and said credit score in relation to said underwriting criteria and said policy rules.

94. The method of claim 91, comprising the additional steps of selecting the term of duration to be offered to said customer for said one or more financial products to vary according to said information from said electronic application and said credit score in relation to said underwriting criteria and said policy rules.

95. The method of claim 91, comprising the additional steps of selecting the fees to be offered to said customer for said one or more financial products to vary according to said information from said electronic application and said credit score in relation to said underwriting criteria and said policy rules.

96. The method of claim 91, comprising the additional steps of selecting the optional items to be offered to said customer for said one or more financial products to vary according to said information from said electronic application and said credit score in relation to said underwriting criteria and said policy rules.

97. A system of application decisioning and pricing for one or more financial products comprising:
storage means for electronically storing one or more underwriting criteria and policy rules for said one or more financial products;
applying means for enabling a customer to apply for said one or more financial products and to provide information corresponding to said one or more underwriting criteria and policy rules for said one or more financial products;
score calculating means for calculating a credit score based on said customer's credit history;
decisioning means for comparing said information provided by said customer through said applying means and said credit score with said one or more underwriting criteria and policy rules to accept or decline said application for said one or more financial product;
financial product adjusting means for adjusting the terms and pricing for said one or more financial products based on said comparison of said information provided by said customer through said applying means and said credit score with said one or more underwriting criteria and policy rules; and
recommending means for recommending said financial products available to said customer and said terms and pricing for said one or more financial products.

98. A system of application decisioning and pricing for one or more financial products comprising:
a storage module that electronically stores one or more underwriting criteria and policy rules for said one or more financial products;
an application module that enables a customer to apply for said one or more financial products and to provide information corresponding to said one or more underwriting criteria and policy rules for said one or more financial products;
a score calculating module that calculates a credit score based on said customer's credit history;
a decisioning module that compares said information provided by said customer through said applying means and said credit score with said one or more underwriting criteria and policy rules to accept or decline said application for said one or more financial product;
a financial product adjusting module that adjusts the terms and pricing for said one or more financial products based on said comparison of said information provided by said customer through said applying means and said credit score with said one or more underwriting criteria and policy rules; and
a recommending module that recommends said financial products available to said customer and said terms and pricing for said one or more financial products.
